(19) United States
(12) Patent Application Publication
(10) Pub. No.: US 2002/0184609 A1
(43) Pub. Date: Dec. 5, 2002

(54) Method and apparatus to produce software

(76) Inventors: Christopher J. Sells, Beaverton, OR (US); Shawn T. Wildermuth, Portland, OR (US)

Correspondence Address: CHARLES MICHO, 112 W 37TH ST, VANCOVVER, WA, 98660, US

(21) Appl. No.: 09/872,204

(22) Filed: May 31, 2001

(51) Int. Cl. G06F 9/44

(52) U.S. Cl. 717/106

(57) ABSTRACT

A method includes applying a test suite to first source code to identify which, if any, wizard was applied to produce at least a portion of the first source code, and to identify a set of options of the identified wizard. When application of the test suite identifies the wizard and the set of options, the identified wizard is operated according to the identified set of options.

### FIELD

The invention relates to the field of tools for producing software.

### BACKGROUND

Modern software production may be a complex, time consuming affair. In order to reduce design time and increase reliability, software developers have increasingly turned to the use of tools which assist in the software production process. One example of such a tool is the Visual Studio which is produced and sold by Microsoft Corporation of Redmond, Wash. Visual Studio includes an integrated development environment including a source code editor, compiler, linker, and run-time debugger for programming languages such as the C and C++ languages.

One type of software design tool is the “wizard” or wizard application. A wizard is software which produces other software. A wizard may prompt a software developer for information, typically through a graphical user interface, in response to which the developer supplies information to the wizard. The wizard may then employ this information, known as options or settings, to produce software. For example, a wizard may prompt a user to specify a feature, such as 3D controls or reference counting. Once the developer specifies the feature, the wizard may then produce the source code statements and other symbols to implement the feature. Of course the wizard may request additional information from the developer, such as the name of a file in which to store the produced software.

The developer may wish to modify, add, or remove features from the software produced by the wizard. However, the developer may subsequently modify the produced software using means other than the wizard. It may be difficult to employ the wizard on this subsequently modified software to add, remove, or modify features, without losing or damaging the subsequent modifications.

### SUMMARY

A method includes applying a test suite to first source code to identify which, if any, wizard was applied to produce at least a portion of the first source code, and to identify a set of options of the identified wizard. When application of the test suite identifies the wizard and the set of options, the identified wizard is operated according to the identified set of options.

### FIGURES

The invention may be better understood with reference to the following figures in light of the accompanying description. The present invention, however, is limited only by the scope of the claims at the concluding portion of the specification.

FIG. 1 shows an embodiment of a software interface in accordance with the present invention.

FIG. 2 shows an embodiment of wizard software in accordance with the present invention.

FIG. 3 shows an embodiment of a directory structure and files in accordance with the present invention.

FIG. 4 shows an embodiment of source code produced by the application of an embodiment of a wizard in accordance with the present invention.

FIG. 5 shows an embodiment of source code modified by a different application of an embodiment of a wizard in accordance with the present invention.

FIG. 6 shows an embodiment of the source code of FIG. 4 modified by means other than a wizard embodiment.

FIG. 7 shows an embodiment of a re-wizarding method in accordance with the present invention.

FIG. 8 shows an embodiment of source code after application of a re-wizarding embodiment in accordance with the present invention.

FIG. 9 shows an embodiment of a wizard guessing method in accordance with the present invention.

FIG. 10 shows an embodiment of a test suite applied by an embodiment of a wizard guessing method in accordance with the present invention.

FIG. 11 shows an apparatus embodiment in accordance with the present invention.

### DESCRIPTION

In general, the invention may be applicable where a set of symbols is to be produced and/or modified, including compiled object code. Numerous references to “one embodiment” or “an embodiment” do not necessarily refer to the same embodiment, although they may.

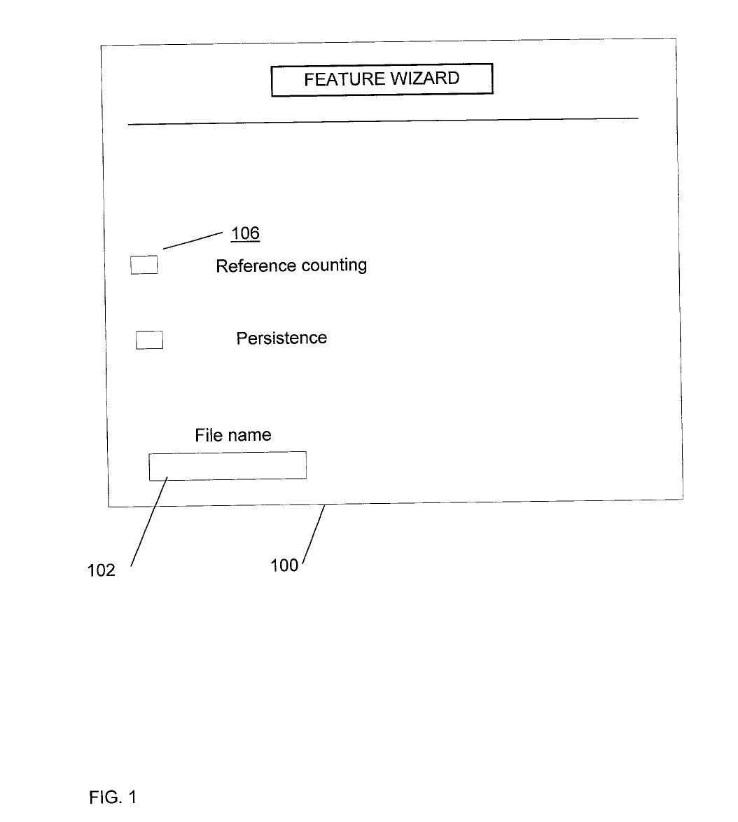

FIG. 1 shows an embodiment 100 of a software interface in accordance with the present invention. The software interface 100 may be employed by a “wizard” software application. Wizard may operate to implement features, capabilities, and other attributes in software source code (which henceforth may be referred to as “the source code to produce”). For example, the wizard may operate to implement a reference counting feature, well known in the art of object oriented software design, using a C++ class definition. Interface 100 may comprise an input field 102 for providing a file name of one or more source code files to produce.

The feature or features to implement may be specified by way of an option such as 106, which selects the reference counting feature. Of course interface 100 is merely one embodiment and many other interfaces could serve a similar purpose of specifying features, capabilities, or other attributes to implement in source code.

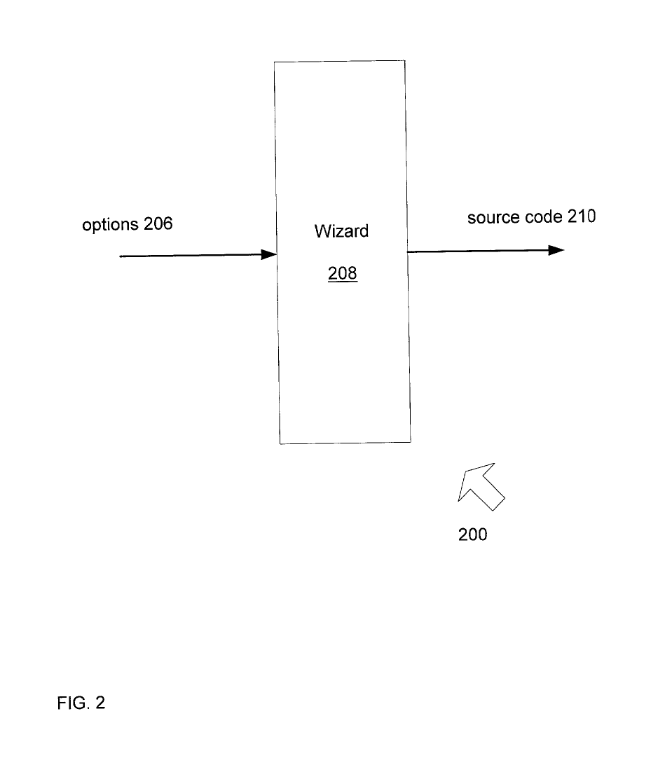

FIG. 2 shows one embodiment of the wizard software 208 in accordance with the present invention. Options 206 are input to wizard 208. Options 206 identify, among other things, the specified features to implement in the source code to produce 210. Wizard 208 then produces source code 210 according to the specified options.

In the following description, numerous references may be made to software classes and class definitions. It should be appreciated and while the invention is applicable to source code including class definitions, it is not limited in this respect and may be applied to source code comprising constructs other than classes. For example, the invention may be applied to software source comprising data structures, arrays, and variable declarations, among other possibilities.

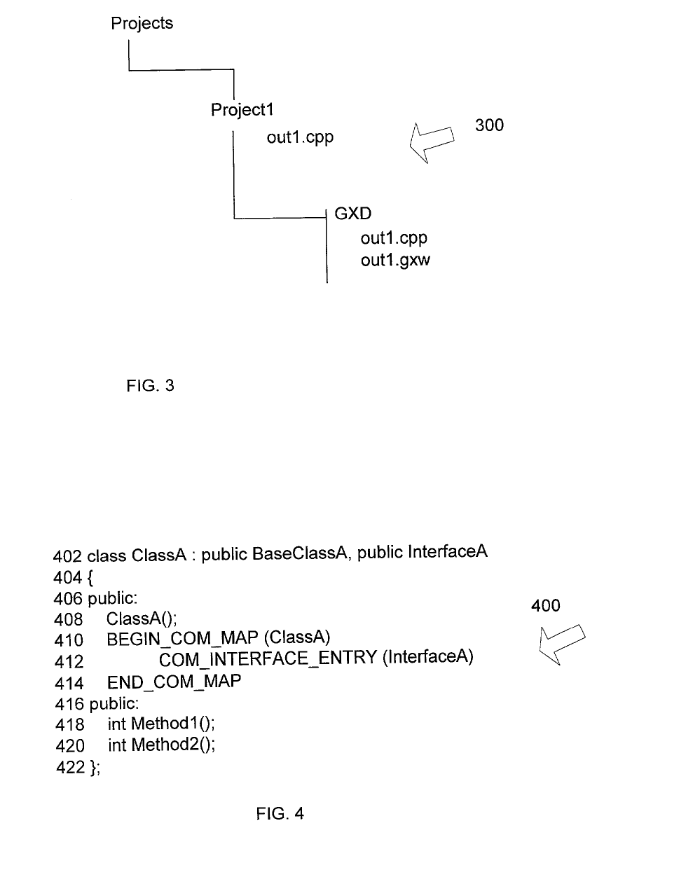

FIG. 3 shows an embodiment 300 of a directory structure and files in accordance with the present invention. A top level directory called Projects comprises the files and subdirectories of various software projects of a software developer. Each software project has a corresponding subdirectory. For example, the project named Project1 has a corresponding subdirectory called Project1. Each project subdirectory comprises various project files, and possibly additional subdirectories. In subdirectory Project1, the file out1.cpp represents a C++ source code file which is produced by the operation of a wizard. This file may be referred to as the “original” out1.cpp file W1.

FIG. 4 shows an embodiment 400 of the original out1.ccp file W1for this particular example project, which of course is only one of practically infinite possible projects. Those skilled in the art will recognize lines 402-408 as rather typical source code for a declaration of a C++ class, this one called ClassA. Line 402 indicates that the class derives from BaseClassA and InterfaceA. Line 412 provides a COM map entry for InterfaceA, well known in the art of software design for Microsoft Windows® platforms. Lines 410-414 will be recognized by those skilled in the art as the declaration for a Microsoft Component Object Model (COM) map for the class. Lines 416-420 declare two methods for the class, Method1( ) and Method2( ). Line 422 closes the class definition.

Returning now to FIG. 3, the Project1 subdirectory further comprises a subdirectory GXD. Of course, the name of the subdirectory may vary in other embodiments. The GXD subdirectory comprises a C++ source file, GXD\out1.cpp, also produced by the wizarding operation. This GXD\out1.cpp file is (initially) identical to the original out1.cpp file W1 produced in the parent Project1 directory. The GXD subdirectory further comprises a file, out1.gxw, which comprises identification of the options (also known as settings) of the wizarding operation applied to produce W1and GXD\out1.cpp.

Modifications to the original out1.cpp file W1in the Project1 subdirectory may now occur by means other than using the wizard which produced the original out1.cpp file W1. Typically, the software developer may add, modify, or delete lines of source code from the out1.cpp file W1using a word processor or other non-wizard tool. Referring momentarily to FIG. 6, an embodiment 600 of a modified original out1.cpp file U is shown. A new line of source code, line 419 comprising Method4( ), has been added by the software developer using a word processor or other means not involving the wizard.

The software developer may now desire to modify the features of the modified out1.cpp file U by operating the wizard a second time. However, merely replacing the original out1.cpp file W1in the Project1 directory would destroy the subsequent (non-wizard) modifications in file U.

Although illustrated in terms of distinct files, it is of course possible that the various sources (original, modified by wizard, modified by non-wizard, etc.) could be stored using other organizations (such as together in a single file, in memory buffers, etc.). The present invention contemplates all manners in which the various sources are stored distinctly from one another.

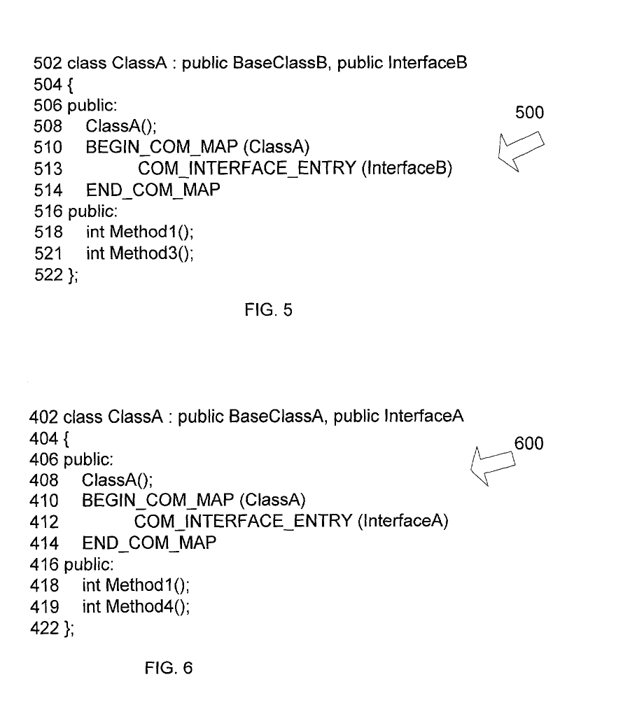

Referring back to FIG. 5, an embodiment 500 of C++ source code produced by a second wizard operation is shown. This source code may be referred to as the re-wizarded out1.cpp, or W2for short. Those skilled in the art will recognize lines 502-508 as rather typical source code for a declaration of a C++ class, this one called ClassA. Line 502 indicates that the class derives from BaseClassB and InterfaceB. Lines 510-514 will be recognized by those skilled in the art as the declaration for a Microsoft Component Object Model (COM) map for the class. Line 513 provides a COM map entry for InterfaceB. Lines 516-521 declare two methods for the class, Method1( ) and Method3( ). Line 522 closes the class definition.

Note that the re-wizarded out1.cpp W2does not contain a declaration of Method4( ), the non-wizard modification made to the original out1.cpp file W1.

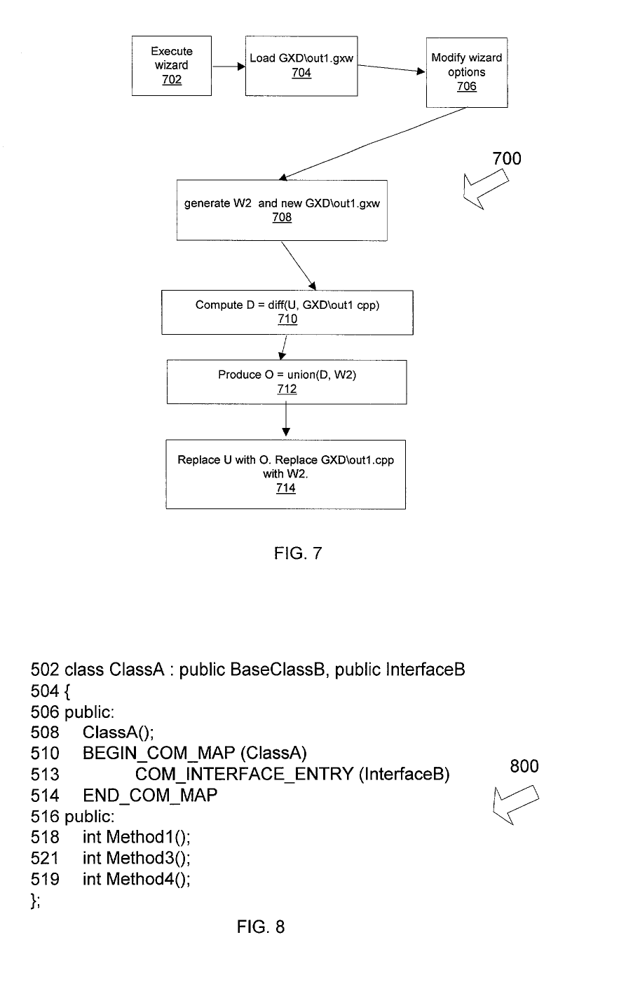

FIG. 7 shows an embodiment 700 of a re-wizarding method in accordance with the present invention. At 702 a wizard is operated. The out1.gxw definitions from a prior wizarding operation are loaded by the wizard at 704. Consequently, the wizard is configured initially with the attributes which were used during the prior operation of the wizard. At 706 attributes are selected to define new or different wizard features. A re-wizarded out1.cpp W2is produced which embodies these new or different features.

At 710, a difference is determined between GXD\out1.cpp, and the modified out1.cpp file U, in the parent Project1 directory. In one embodiment, this difference may be determined by first ascertaining the intersecting (common) symbols between the two out1.cpp files, and then removing the intersecting symbols from both. The difference may be ascertained, in one embodiment, using the well-known “diff2” algorithm. This difference represents the non-wizard modifications to the original out1.cpp file W1. At 712, the difference is applied to the re-wizarded out1.cpp W2. As a result, the re-wizarded out1.cpp W2now includes both the non-wizard modifications to the original out1.cpp file W1, and the features resulting from the second wizarding operation. Of course, applying the differences may mean both adding and removing symbols from the re-wizarded out1.cpp W2.

In one embodiment, the re-wizarded out1.cpp W2, including non-wizard modifications extracted from the modified out1.cpp file U, replaces the original out1.cpp file W1in the Project1 subdirectory. This file may be referred to as file O. The re-wizarded out1.cpp W2, without the non-wizard modifications, and the out1.gxw options file for the re-wizarded out1.cpp W2, replace files GXD\out1.cpp and GXD\out1.gxw.

FIG. 8 shows an embodiment 800 of out1.cpp in the Project1 subdirectory, after application of a re-wizarding embodiment and in accordance with the present invention (e.g. the file O). The embodiment 800 includes the symbols of the re-wizarded out1.cpp W2, such as the class declaration line 502, which indicates that the class derives from BaseClassB and InterfaceB. Line 513 is included in the COM map for the class to provide a map entry for InterfaceB. Embodiment 800 also comprises the non-wizard modifications to the original out1.cpp W1, e.g. line 519 comprising the declaration of Method4( ).

Under some circumstances, it may be desirable to re-wizard a source file, but the original out1.cpp W1and out.gxw (original options) may be unavailable. This could happen, for example, if the GXD subdirectory for the project is inadvertently lost or destroyed. In this case, a process of “wizard guessing” may be applied to the modified out1.cpp file U. Wizard guessing may be applied to determine the identify the wizard which produced the original out1.cpp file U, and to determine the options which were applied by that wizard. Once the wizard and options are known, a wizard operation may occur to produce new source and option files, in a manner to be described.

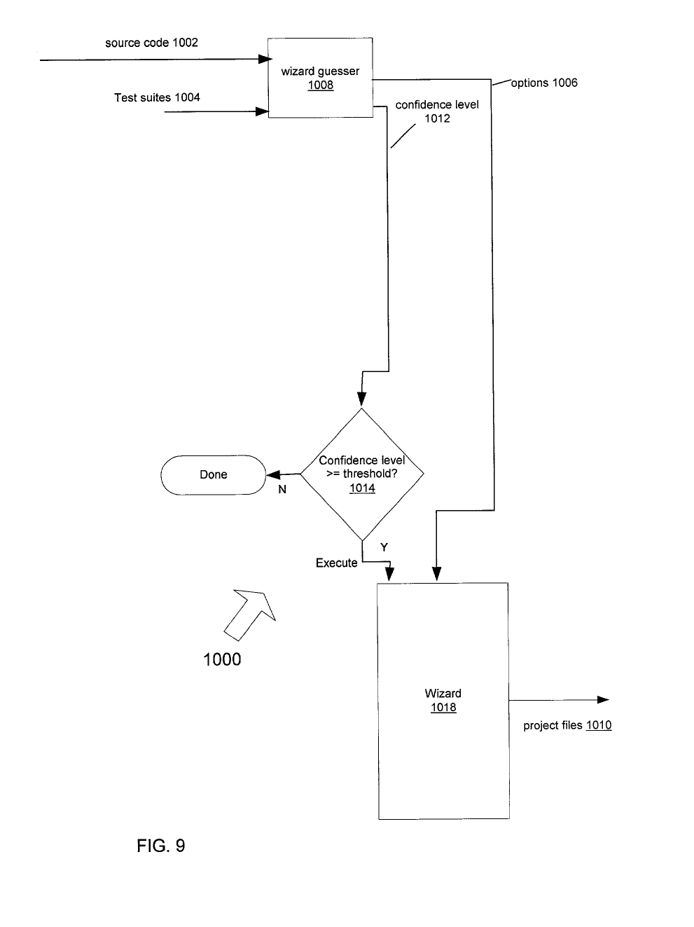

FIG. 9 shows an embodiment 1000 of a wizard guessing method in accordance with the present invention. The modified original out1.cpp file U 1002 is supplied to the wizard guesser 1008 (of course, the actual name of the source file will vary by project). The wizard guesser 1008 also inputs test suites 1004. The test suites 1004 define tests to perform on the modified original out1.cpp file U 1002. The wizard guesser 1008 analyzes the modified out1.cpp file U 1002 by applying the tests defined by test suites 1004.

The wizard guesser 1008 identifies, according to the test suites, the wizard which was applied to produce at least a portion of the symbols in the modified original out1.cpp file U 1002. The wizard guesser 1008 further identifies the options 1006 applied by the identified wizard when producing the modified out1.cpp file U 1002. In one embodiment, the wizard guesser 1008 outputs a confidence level 1012 which indicates the degree of confidence, probability, or likelihood that the identified wizard and identified options 1006 are accurate. The confidence level 1012 is tested at 1014 to determine whether it meets predetermined criteria, to determine whether to proceed with wizarding.

In one embodiment, it is determined whether the confidence level 1012 is greater than or equal to a threshhold value. Of course, other tests might include determining whether the confidence level 1012 is below a certain threshold, or falls within a range of values, depending on the particular predetermined criteria. At 1014, when the confidence level is greater than a predetermined threshold value, the wizard is treated as “identified” and is executed at 1018 in a re-wizarding operation, resulting in recreation of the project files 1010, and preserving any non-wizard modifications.

As previously described, re-wizarding may add, change, or remove features from the source code 1002 according to changes in the wizard options. New GXD\out1.cpp and GXD\out1.gxw files comprising the new or changed features may be produced by the wizarding operation and stored in the GXD subdirectory (which also my need to be reproduced). A new or changed out1.cpp file O, which embodies features according to the identified wizard options 1006 and any non-wizard modifications to the modified original out1.cpp file U 1002, may be created and stored in the Project1 directory.

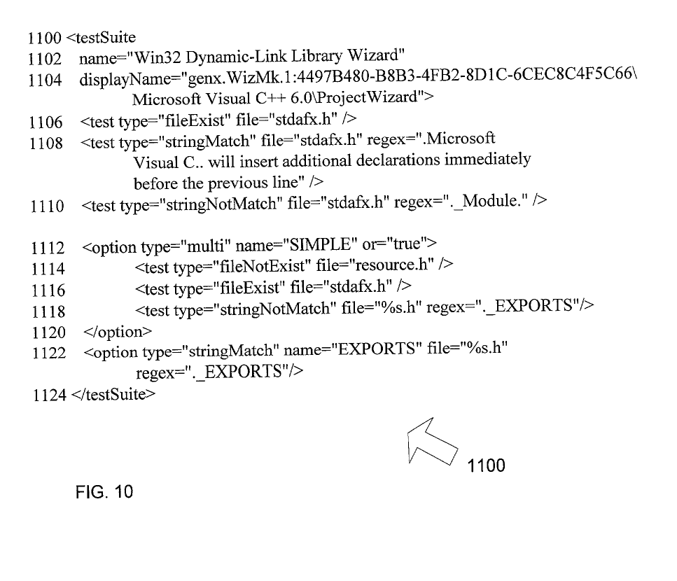

FIG. 10 shows an embodiment 1100 of a test suite in accordance with the present invention. Embodiment 1100 is of course only one example of a test suite, and any number of variations are possible. In one embodiment, multiple test suites may be stored within a single file. Embodiment 1100 is an XML definition of a test suite, designed to identify the wizard applied by a prior operation on software. The test suite body comprises rules to apply to identify the wizard. The test suite body begins with a declaration on lines 1100 through 1104. The test suite declaration includes two attributes; name and displayname. Attribute name simply provides a user-friendly identification of the test suite. Attribute displayname defines an object identifier for the wizard software which the test suite will test for. In other words, attribute displayname provides a mechanism for locating and executing the wizard once it is identified. The end of the test suite body is defined at line 1124.

Lines 1104 to 1124 comprise the body of the test suite. The body of the test suite includes test and option elements. At line 1106, a test element is declared with two attributes; type and file. Attribute type has a value of “fileexist”. Attribute file has a value of “STDAFX.H”. Together, these attributes define a test to ascertain whether the file STDAFX.H exists among the project files of the source code to test. In one embodiment, if this test is met, the confidence level of the test suite as a whole is increased. Otherwise, the confidence level of the test suite as a whole may remain unchanged or may be decreased. Of course, the terms “increased” and “decreased” are relative, and other embodiments could “decrease” the confidence level while still indicating a higher degree of confidence (and vice versa).

Another test is declared at line 1108. This test has three attributes; type, file, and regex. Attribute type has a value of “stringmatch”; attribute file has a value of “STDAFX.H”. Together, these attributes identify a test whereby the contents of file STDAFX.H are searched for a matching regular expression. The regular expression to match is defined by attribute regex as “genx.WizMk.1:4497B480-B8B3-4FB2-8D1C-6CEC8C4F5C66\Microsoft Visual C++ 6.0\ProjectWizard”. [Inventor: what do the periods in the regular expression mean? Are they literal?] In other words, if the project file STDAFX.H contains a match for this regular expression, the confidence level of the test suite may increased.

At line 1110, a test is defined having three attributes; stringnotmatch, file, and regex. This test will search the contents of the file STDFAX.H for a match with the regular expression“._Module.” The test is met only if the regular expression is not matched in the contents of the file. If the test is met, the confidence level of the test suite may be increased.

In one embodiment, the tests defined in the test suite may be performed in the order defined in the XML file. In other embodiments the tests may be performed in different orders.

At line 1112, an option element is defined. The body of option element 1112 (lines 1114-1118) comprises additional tests to determine whether a particular wizard option was enabled when a wizard was applied to produce or modify the software. The option element declaration at line 1112 comprises three attributes; type, name, and or. The type attribute has a value of “multi”, which indicates that multiple test elements may be comprised by the option element. The value of the name attribute identifies the wizard option (e.g. setting) which the option element is to test for. In this case, the test is for an option identified as “SIMPLE”. The value of the or attribute indicates the manner in which the results of the tests comprised by the option element are to be combined. If or has a value “TRUE”, the test results are combined using a logical OR operation. The value of the or attribute may be set to “FALSE” to indicate that the test results should be combined in a logical AND operation. When the value of the or attribute is “TRUE”, the wizard option named in the option element declaration is identified when any one of the tests comprised by the option element is met. When the value of the or attribute is set to “FALSE”, the wizard option named in the option element declaration is identified when all of the tests comprised by the option element are met.

In embodiment 1100, the option named “SIMPLE” comprises three tests. One of these tests is declared at line 1114 and has two attributes; type and file. Attribute type has the value “filenotexist.” Attribute file has the value “RESOURCE.H.” Together, these attributes identify a test to check for the existence of file “RESOURCE.H” in the project comprising the source code. The test is met when the file does not exist in the project. The option element comprising this test has an or attribute set to “TRUE”. Thus, if the test at 1114 is met, the option “SIMPLE” is identified as having been applied to this project by a prior operation of a wizard. Of course, identifying an option may also increase the confidence level that the wizard the test suite is attempting to identify is the right one. In one embodiment, if the test at line 1114 is not met, the test at line 1116 may be next performed. Of course, it need not be the case that the tests are carried out in a particular order. This next test is similar to the test defined at line 1106, and is met when the file STDAFX.H is ascertained to exist in the project.

At 1118, a test is defined with three attributes; type, file, and regex. The value of attribute file is “%s.h”, indicating that files in the project with an extension .h will be examined in performing the test. The attribute regex has the value “._EXPORTS”, indicating that the test should attempt to match this regular expression in the files. The type attribute has a value “stringnotmatch”, indicating that the test is met when the regular expression is not identified in any of the files.

Line 1120 comprises the closing statement for the option element.

In one embodiment, the element and attribute declarations of the test suite conform to the format of XML Version 1.0. Of course, this example comprises only some of the possible elements and attributes of a test suite. Additional or fewer elements and attributes, or attributes and elements with different names, are also contemplated. In one embodiment, the format of the values of the regex attributes in the test elements conform to well-known regular expression formats.

Line 1122 shows an option element having four attributes; type, name, file, and regex. The type attribute does not have a value of “multi”, therefore, the option element does not have a body comprising multiple test elements. Instead, the test for the option is defined within the option element declaration itself. The name attribute has a value of “EXPORTS”, indicating the name of the wizard option the test will attempt to identify. The file attribute has a value of “%s.h”, indicating that project files having a .h extension may be examined when performing the test for the option. The type, file, and regex attributes define a test whereby the content of files in the project directory having a .h extension are searched to match the regular expression “._EXPORTS”.

The following description provides an exemplary XML schema for test suites according to an embodiment of the present invention. In one embodiment, the element and attribute names are not case-sensitive; upper case may be applied in some instances to make the names more readable, but is not required.

One Embodiment of a Test Suite XML Schema

Elements

wizardGuessing: Parent element for possibly multiple testSuite elements.

testSuite: Defines one or more tests to identify the wizard which operated upon a project, and the wizard options (settings) which were in effect. This element is comprised by the body of the wizardGuessing element.

name: The name to apply to the identified wizard

displayName: [Inventor: This is the moniker required for creation of the wizard. Unclear to me what this means.]

test: Defines a test.

Attributes:

type: The type of the test—supported values include:

fileExist—Return true if the file exists

Required Attributes: file

Optional Attributes: filealt

fileNotExist—Return true if the file (see below) does not exist

Required Attributes: file

Optional Attributes: filealt

stringMatch—Return true if a match of a regular expression is made with the contents of the file

Required Attributes: file, regex

Optional Attributes: filealt

stringNotMatch—Return true if a match of a regular expression is not made with the contents of the file

Required Attributes: file, regex

Optional Attributes: filealt

file: Specifies the files to test. Accepts C language “printf”-style templates. If the filealt attribute is not present, the template “%s” is replaced with the project name. For example, in a Microsoft Visual C++ project with a project file named mfcexe.dsp, file=“%s.cpp” is interpreted as file=“mfcexe.dsp”).

filealt: Specifies an option name to replace the “%s” template in the file attribute. The option should be identified before this test is performed.

regex: Specifies a regular expression

option: Defines one or more tests to identify a wizard option (setting).

Attributes:

type: The type of test to perform

fileExist—(same as for test element, above)

fileNotExist—(same as for test element, above)

stringMatch—(same as for test element, above)

stringNotMatch—(same as for test element, above)

genFileName—Return a file name according to the file and filealt attributes, as defined for the test element, above.

Required Attributes: name, file, filetype

Optional Attributes: filealt, weight

stringRetrieve—Returns a string based upon two regular expressions. The first regular expression matches a first string, the second regular expression matches a substring of the first string.

Required Attributes: name, file, regex, subregex, subpresize, subpostsize

Optional Attributes: filealt, weight

searchStringMatch—Returns the name of a file having contents which match a regular expression.

Required Attributes: name, ext, regex, filetype

Optional Attributes: weight

searchRetrievedStringMatch—Returns the name of a file having a first string matching a first regular expression, and a substring of the first string matching a second regular expression.

Required Attributes: name, file, ext, regex, subregex, subpresize, subpostsize

Optional Attributes: filealt, weight

multi—Indicates that the option element may comprise multiple test elements. True/False test results may be ANDed or ORed, according to the or attribute. With AND, all tests must be true for the option to be identified; with OR, only one of the tests need be true.

Required Attributes: name

Optional Attributes: or, weight

name: Name of the wizard option to test for.

file: See the description under the test element.

filealt: See the description under the test element.

filetype: When the type attribute indicates a file name is to be returned, this attribute defines the format of the returned file name. The supported types are:

filename—return the file name without the extension

filenamefull—Return the file name with extension

path—Return the path to the file without the file name or extension

pathfull—Return the full path of the file including file name and extension.

regex: See the description under the test element.

subregex: Specifies the substring to match in the string matching the regex attribute. The subpresize and subpostsize attributes are used in conjunction to trim the resulting match. For example, if regex matches the string “IDR_HELLOTHEREMENU 120;” subregex could be set to “R_[A-Z]+MENU” to match the substring “R_HELLOTHEREMENU”. The subpresize attribute could be set to 2, and the subpostsize attribute set to 4, which would trim the final matched string to “HELLOTHERE”.

subpresize: See the description of the subregex attribute.

subpostsize: See the description of the subregex attribute.

ext: Specifies a file extension for files to search. The format is .ext, e.g. ‘.h’ or

weight: Specifies whether identifying the option increases the confidence level of the test suite results. Zero (the default) indicates that no weight should be assigned. 1 indicates that a normal test weight should be assigned.

or: If set to ‘true’, a multi typed option will have a return result which is the logical OR of its constituent test results. Defaults to ‘false’, indicating the option will have a return result which is the logical OR of its constituent test results.

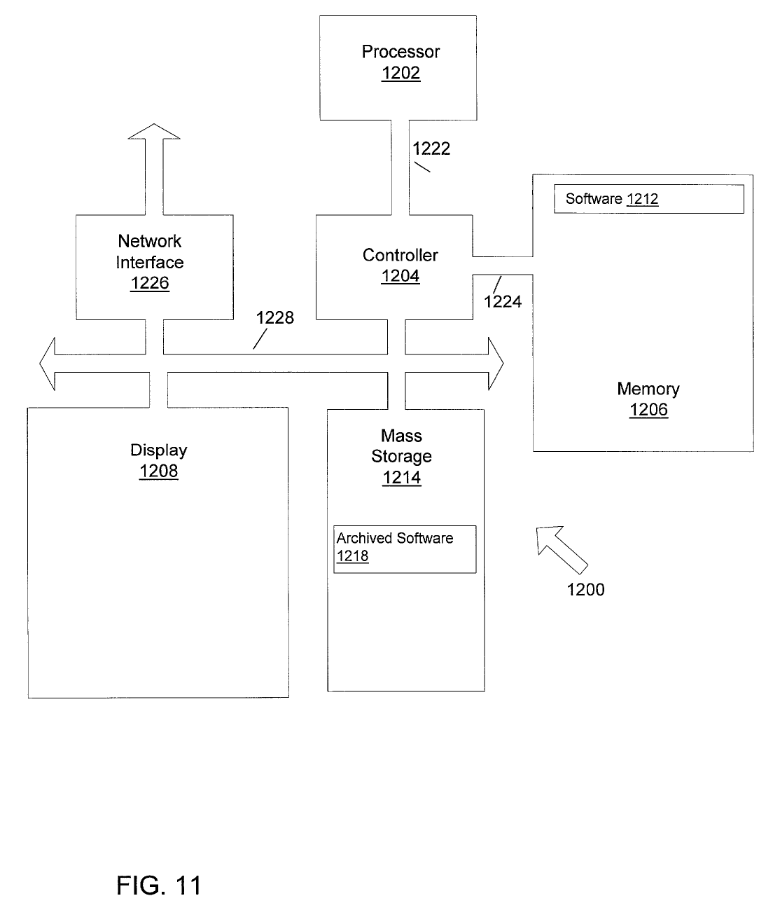

FIG. 11 shows an apparatus embodiment 1200 in accordance with the present invention. Embodiment 1200 comprises a processor 1202 coupled to a controller 1204 by way of a processor bus 1222, commonly referred to as a front side bus. Bus controller 1204 is coupled to memory 1206 via memory bus 1224. Bus controller 1204 is also coupled to various peripheral devices such as mass storage 1214, network interface 1226, and display 1208 via I/O bus 1228. Network interface 1226 provides apparatus 1200 with access to networks such as the Internet or corporate intranets. Memory 1206 stores a software embodiment 1212 to perform re-wizarding and/or wizard guessing in accordance with the present invention. Software 1212 may be stored in memory 1206 in a form suitable for access and execution by processor 1202. An archived loadable form 1218 of software 1212 may be stored by mass storage 1214 for loading into memory 1206 for execution by processor 1202. Mass storage 1214 may comprise any form of non-volatile memory including hard drives, CD ROM drives, ZIP drives, diskettes, and so on.

Memory 1206 is typically a form of random access memory (RAM) such as a DRAM, flash memory, SDRAM, and so on. Memory 1206 supplies the instructions of software 1212 stored therein to processor 1202 for execution. Execution of software embodiment 1212 by processor 1202 may result in a process to carry out re-wizarding and/or wizard guessing, in accordance with the present invention.

While certain features of the invention have been illustrated as described herein, many modifications, substitutions, changes and equivalents will now occur to those skilled in the art. It is, therefor, to be understood that the appended claims are intended to cover all such embodiments and changes as fall within the true spirit of the invention.

What is claimed is:

1. A method comprising:
applying a test suite to first source code to identify which, if any, wizard was applied to produce at least a portion of the first source code, and to identify a set of options of the identified wizard;
when application of the test suite identifies the wizard and the set of options, operating the identified wizard according to the identified set of options.

2. The method of claim 1 wherein operating the identified wizard on the source code according to the identified set of options further comprises:
producing second source code according to the identified options;
identifying differences between the second source code and the first source code; and
applying the differences to the second source code.

3. The method of claim 1 wherein identifying differences between the second source code and the first source code further comprises:
applying a diff algorithm to the first and second source codes.

4. The method of claim 1 wherein the test suite further comprises:
a plurality of XML elements, at least one of the elements defining at least one test to facilitate identification of the wizard.

5. The method of claim 4 wherein the XML elements further comprise:
at least one XML-formatted test element defining a test to search the first source code for one of a match and failure to match a regular expression.

6. The method of claim 4 wherein the XML elements further comprise:
at least one XML-formatted test element defining a test for determining one of the existence and non-existence of a file.

7. The method of claim 4 wherein the XML elements further comprise:
at least one XML-formatted test element defining a test to identify a wizard option applied when the wizard was applied to produce at least a portion of the first source code.

8. The method of claim 4 further comprising:
increasing a confidence level in the identification of the wizard as a result of meeting the at least one test to further identify the wizard.

9. The method of claim 8 further comprising:
operating the identified wizard on the first source code when the confidence level meets a predetermined criteria.

10. A method comprising:
applying a wizard to produce original source code and first source code according to first wizard options;
storing the first source code and first wizard options distinctly from the original source code;
identifying non-wizard modifications to the original source code;
applying the wizard to produce second source code according to second wizard options; and
applying the non-wizard modifications to the second source code.

11. The method of claim 10 wherein identifying non-wizard modifications to the original source code further comprises:
applying a diff algorithm to the original source code and the first source code.

12. The method of claim 10 further comprising:
replacing the original source code with the second source code which includes the non-wizard modifications.

13. The method of claim 12 further comprising:
replacing the first source code with the second source code which does not include the non-wizard modifications.

14. An article comprising:
a machine-readable medium having stored thereon instructions which, when executed by a processor, result in:
applying a test suite to first source code to identify which, if any, wizard was applied to produce at least a portion of the first source code, and to identify a set of options of the identified wizard;
when application of the test suite identifies the wizard and the set of options, operating the identified wizard according to the identified set of options.

15. The article of claim 14 further comprising instructions which, when executed by the processor to operate the identified wizard on the source code according to the identified set of options, further results in:
producing second source code according to the identified options;
identifying differences between the second source code and the first source code; and
applying the differences to the second source code.

16. The article of claim 14 wherein further comprising instructions which, when executed by the processor to identify differences between the second source code and the first source code, further results in:
applying a diff algorithm to the first and second source codes.

17. The article of claim 14 wherein the test suite further comprises:
a plurality of XML elements, at least one of the elements defining at least one test to facilitate identification of the wizard.

18. The article of claim 17 wherein the XML elements further comprise:
at least one XML-formatted test element defining a test to search the first source code for one of a match and failure to match a regular expression.

19. The article of claim 17 wherein the XML elements further comprise:
at least one XML-formatted test element defining a test for determining one of the existence and non-existence of a file.

20. The article of claim 17 wherein the XML elements further comprise:
at least one XML-formatted test element defining a test to identify a wizard option applied when the wizard was applied to produce at least a portion of the first source code.
